(19) United States
(12) Patent Application Publication
(10) Pub. No.: US 2011/0154679 A1
(43) Pub. Date: Jun. 30, 2011

(54) AMBIENT AIR SUPPLY DRYER

(76) Inventor: Monnie Watson, Greenbrier, AR (US)

(21) Appl. No.: 12/648,303

(22) Filed: Dec. 29, 2009

(51) Int. Cl. F26B 11/02; F16L 11/00

(52) U.S. Cl. 34/132; 138/120

(57) ABSTRACT

A flexible duct system for providing hot ambient air to a clothes dryer comprising: an attic transfer duct assembly, where a first end of said attic transfer duct assembly extends into an attic area to access ambient air; a connecting duct assembly, where the connecting duct assembly connects to the clothes dryer; and a means to connect the transfer duct assembly to the connecting duct assembly, where said means transfers ambient air from the attic to the clothes dryer. In one exemplary embodiment, the means to connect includes an elbow connector. In most applications, the connecting duct assembly attaches to a dryer manifold within the clothes dryer, where the air flow through the dryer manifold transfers through a heating element and into the tumbling area of the dryer. In another exemplary embodiment of the present invention, the heating element may include an off and on switch.

### BACKGROUND OF THE INVENTION

1. Field of Invention

The present invention relates to a clothes dryer that utilizes hot ambient air as a dry air source.

2. Description of Related Art

A common household appliance used for drying clothes and other textiles is a tumbling clothes dryer. The clothes dryer may consist of a tumbling drum where heated air is circulated in order to remove moisture within wet clothing placed in the dryer. The tumbling dryer rotates at a relatively slow speed and allows the clothing to toss about in the tumbler. The conventional clothes dryer is usually fueled by either electricity or in some cases natural gas. In either application, a heating element or a means to heat the ambient cool air that may exist near and around the dryer is necessary. The dryer draws the ambient air through the heater and then emits the heated air into the tumbler to perform the drying function.

The clothes dryers of the prior art include inefficiencies and require the use of unnecessary energy because of the typical functionality associated with a clothes dryer. The clothes dryer pulls cool air, heats it, then the heated air is emitted in the tumbler and released after use. The heat air generated by the heating element is not reused or salvaged in any manner and is usually released and vented through an exit vent. Other types of clothes dryers may utilize other methods of moisture removal or heat exchange such as heat pump dryers, steam compression dryers, dehumidifier dryers, convectant dryers or solar dryers. Many of the alternative types of clothes dryers are expensive and therefore not cost efficient to manufacture or to utilize on a wide basis due to cost.

Examples of clothes dryers that may attempt to utilize pre-heated air include U.S. Pat. No. 4,873,773 which discloses a portable clothes dryer that includes a bag having minute passages for outflow of air where the bag allows for the introduction of hot air through a forced air heating vent or air register and therefore the heated air circulates around the clothing within the bag to remove moisture from the clothing fabric. Another example of using pre-heated air to dry clothing is U.S. Pat. No. 5,437,106 which discloses a device that consists of a clothes rack that attaches to the residential air conditioning condensing unit and is portable, rotates and embodies the adjustment of an adjustable mounting base where pre-heated air from the condensing unit is circulated through the wet garments and therefore performs a drying function.

The objective of the present invention is to utilize hot ambient air for circulation within a traditional clothes dryer and therefore alleviate the need for utilizing a heating element. The present invention reduces energy costs and provides an alternative to the traditional clothes dryer.

### SUMMARY OF THE INVENTION

The present invention relates to a flexible duct system for providing hot ambient air to a clothes dryer comprising: an attic transfer duct assembly, where a first end of said attic transfer duct assembly extends into an attic area to access ambient air; a connecting duct assembly, where the connecting duct assembly connects to the clothes dryer; and a means to connect the transfer duct assembly to the connecting duct assembly, where said means transfers ambient air from the attic to the clothes dryer. In one exemplary embodiment, the means to connect includes an elbow connector. In most applications, the connecting duct assembly attaches to a dryer manifold within the clothes dryer, where the air flow through the dryer manifold transfers through a heating element and into the tumbling area of the dryer. In another exemplary embodiment of the present invention, the heating element may include an off and on switch.

### BRIEF DESCRIPTION OF DRAWINGS

FIG. 1 depicts a duct venting system according to the present invention.

FIG. 2 shows attachment of the duct venting system to a traditional clothes dryer panel.

### DETAILED DESCRIPTION

The present invention relates to a flexible duct system that is installed to utilize hot ambient air extracted from spaces in a residential building as a source of hot air for a clothes dryer. The hot ambient air may exist in an attic area as one example and the present invention transports this hot air as a hot air supply for a traditional clothes dryer. This utilization of the hot air therefore conserves energy and provides the consumer with an alternative for a conventional clothes dryer. The use of hot ambient air therefore negates the use of a heating element within the clothes dryer to heat the cool ambient air that may be near the clothes dryer.

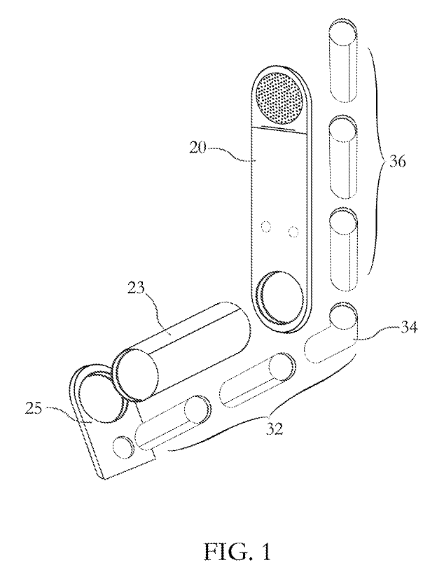

A schematic representation of a flexible duct system according to the present invention is depicted in FIG. 1. As depicted in the schematic an attic air transfer duct 36 is extended to the attic area of a home or building. The ambient air within an attic is usually substantially warmer than ambient air in the living areas of a home or building. This situation is especially true during the warmer months of the year. Further, use of such hot attic air is very accessible in warmer climates. The attic transfer duct 36 extends to an elbow connector 34. The elbow connector provides a connection for a connecting duct assembly 32 that extends into a conventional clothes dryer. The connecting duct 32 connects to a dryer manifold 25 and therefore transfers the heat into a heating element 23. The advantage of using the flexible duct system according to the present invention is that the user may now shut off or eliminate the use of the heating element 23. Therefore the air that transfers through the heating element is already hot or warm enough to perform the drying function associated with the clothes dryer.

The heating element 23 transfers the warm air into the dryer intake 20 and the warm air is then emitted into the tumbler system of the clothes dryer. By utilizing this pre-heated or warm ambient air the clothes dryer uses less energy and the only required function involves tumbling the clothing within the clothing tumbler.

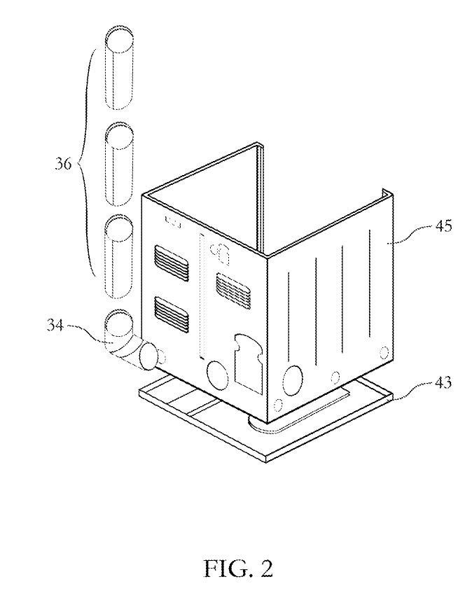

FIG. 2 depicts the connection of the air transfer duct 36 from the attic area to the elbow connector 34 and into a back panel of a dryer panel cover 45. The elbow connector 34 connects into the air intake for the dryer. Normally the air intake pulls cool ambient air that needs to be heated through the heating element 23. However the heating element may be disconnected or switched to an off position when using the hot ambient air from the attic. The advantage of using the system according to the present invention is that if the air in the attic is insufficient for use in the dryer the heating element may be implemented to heat the air to a sufficient temperature in order to effectively dry the clothes. In one exemplary embodiment of the present invention, the heating element may be able to be switched to the off position and then gradually implemented to increase the heating function as necessary based upon the temperature of the air input from the attic. The dryer panel cover 45 is normally placed upon a dryer base plate 43 as depicted in FIG. 2.

The flexible duct system according to the present invention therefore reduces residential energy consumption as related to clothes drying and further allows for a more efficient use of hot air in an attic area. The flexible duct system according to the present invention may be manufactured of sheet metal as normally associated with such systems and connected through a means as known in the prior art. One additional advantage is that the removal of the hot air from the attic helps to regulate the temperature of the environment in the home and therefore reduces the need for additional cooling in areas that would be normally warmer due to the existing hot air in the attic.

What is claimed is:

1. A flexible duct system for providing hot ambient air to a clothes dryer comprising:
a. an attic transfer duct assembly, where a first end of said attic transfer duct assembly extends into an attic area to access ambient air;
b. a connecting duct assembly, where the connecting duct assembly connects to the clothes dryer; and
c. a means to connect the transfer duct assembly to the connecting duct assembly, where said means transfers ambient air from the attic to the clothes dryer.

2. The flexible duct system according to claim 1, where the means to connect includes an elbow connector.

3. The flexible duct system according to claim 1, where said connecting duct assembly attaches to a dryer manifold within the clothes dryer.

4. The flexible duct system according to claim 3, where the air flow through the dryer manifold transfers through a heating element and into the tumbling area of the dryer.

5. The flexible duct system according to claim 4, where said heating element includes an off and on switch.

6. The flexible duct system according to claim 4, where said heating element includes a means to gradually increase the functionality of the heating element based upon the temperature of the air transferred through the heating element.
